(19) United States
(12) Patent Application Publication
(10) Pub. No.: US 2019/0328492 A1
(43) Pub. Date: Oct. 31, 2019

(54) ORTHODONTIC BUTTON

(71) Applicant: Todd Evan Dickerson, Phoenix, AZ (US)

(72) Inventor: Todd Evan Dickerson, Phoenix, AZ (US)

(21) Appl. No.: 15/964,685

(22) Filed: Apr. 27, 2018

(51) Int. Cl. A61C 7/14

(52) U.S. Cl. CPC A61C 7/14; A61C 7/023

(57) ABSTRACT

An orthodontic button has a base for bonding attachment to a tooth. A substantially vertical slot extends into the outer face of the button, and divides the button into a smaller lateral segment covering a smaller portion of the base and a larger lateral segment covering a larger portion of the base. A post on the larger lateral segment provides a point of attachment for removably engaging an elastic to the button. Exerting a lateral compressive force on the smaller lateral segment and the larger lateral segment compresses the slot and releases the base from the tooth.

### BACKGROUND OF THE INVENTION

### Field of the Invention

The present invention relates generally to the field of orthodontic appliances. More specifically, the present invention discloses an orthodontic button for removably attaching an elastic that includes an offset vertical slot to facilitate debonding the button from a tooth.

### Statement of the Problem

Elastics are widely used in orthodontic treatment to exert a tensile force between two points in the dental anatomy. For example, elastics are commonly used for closing gaps between teeth, or for moving teeth. An elastic must be attached to anchor points at each end. A wide variety of orthodontic appliances can be used to removably engage the ends of an elastic, such as brackets, aligners and archwires.

A variety of small buttons are also used to attach elastics to individual teeth. A button typically includes a base for bonding the button to the surface of a tooth, and a post, hook or other protrusion to engage the elastic. The button is usually bonded to the tooth with a conventional adhesive. However, the button must be removed at the end of this phase of treatment. The conventional way to do this has been to grip the button with pliers and exert sufficient force to break the adhesive bond between the base of the button and the surface of the tooth. Unfortunately, such forces can cause patient discomfort, particular if torque is applied to the tooth. There is also a substantial risk that the button will break or that segments of the adhesive will remain attached to the tooth. This often requires grinding to fully remove the button and adhesive, which can be an unpleasant experience for the patient. In light of these difficulties, there is a need for an orthodontic button that can be easily removed in one piece, and without requiring excess force or grinding.

### Solution to the Problem

The present invention addresses these shortcomings by providing an orthodontic appliance having a vertical slot that is laterally offset. The slot divides the body of the button into a larger lateral segment and a smaller lateral segment. Pliers can be used to exert a compressive force on these lateral segments to compress the vertical slot and release the base from the tooth. In particular, the smaller lateral segment will tend to pivot about its base as it is compressed into the vertical slot, thereby peeling the base of the button from the tooth, beginning at the underlying lateral edge of the base. The entire button can then be easily released from the tooth in one piece. Due to the leverage provided by the shape of the smaller lateral segment and the relatively small surface area of the underlying portion of the base, only minimal force is required to debond the button.

### SUMMARY OF THE INVENTION

This invention provides an orthodontic button having a base for bonding attachment to a tooth. A substantially vertical slot extends into the outer face of the button, and divides the button into a smaller lateral segment covering a smaller portion of the base and a larger lateral segment covering a larger portion of the base. A post on the larger lateral segment provides a point of attachment for removably engaging an elastic to the button. Exerting a lateral compressive force on the smaller lateral segment and the larger lateral segment compresses the slot and releases the base from the tooth.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is an axonometric view of the orthodontic button 20.

FIG. 2 is a bottom view of the orthodontic button 20.

FIG. 3 is a side elevational view of the orthodontic button 20.

FIG. 4 is a side elevational view of the orthodontic button 20 bonded to a tooth 10 with an elastic 30 attached to the orthodontic button 20.

FIG. 5 is a bottom view of the orthodontic button 20 and tooth 10 showing compressive forces being exerted on the orthodontic button 20 to debond it from the tooth 10.

### DETAILED DESCRIPTION OF THE INVENTION

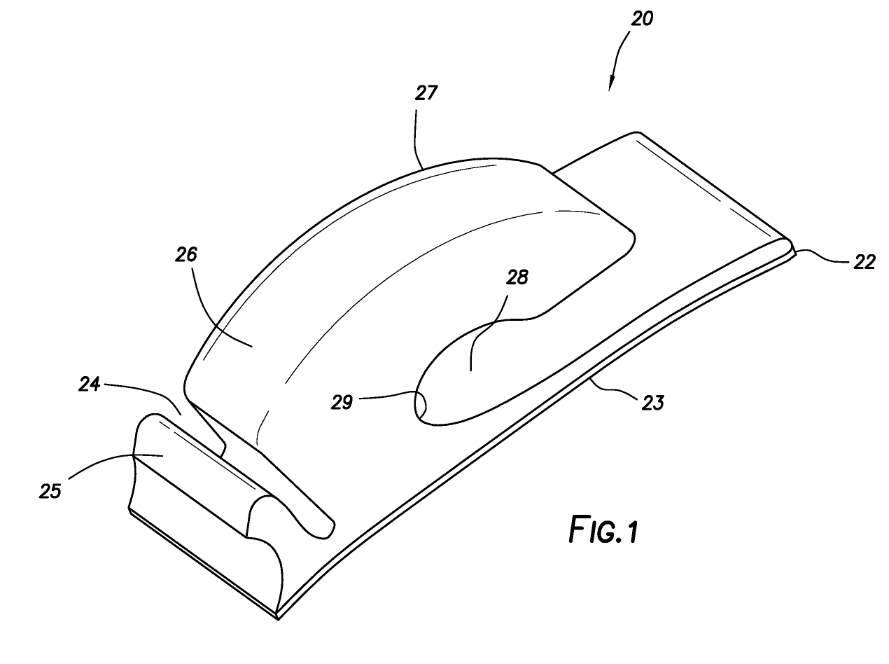

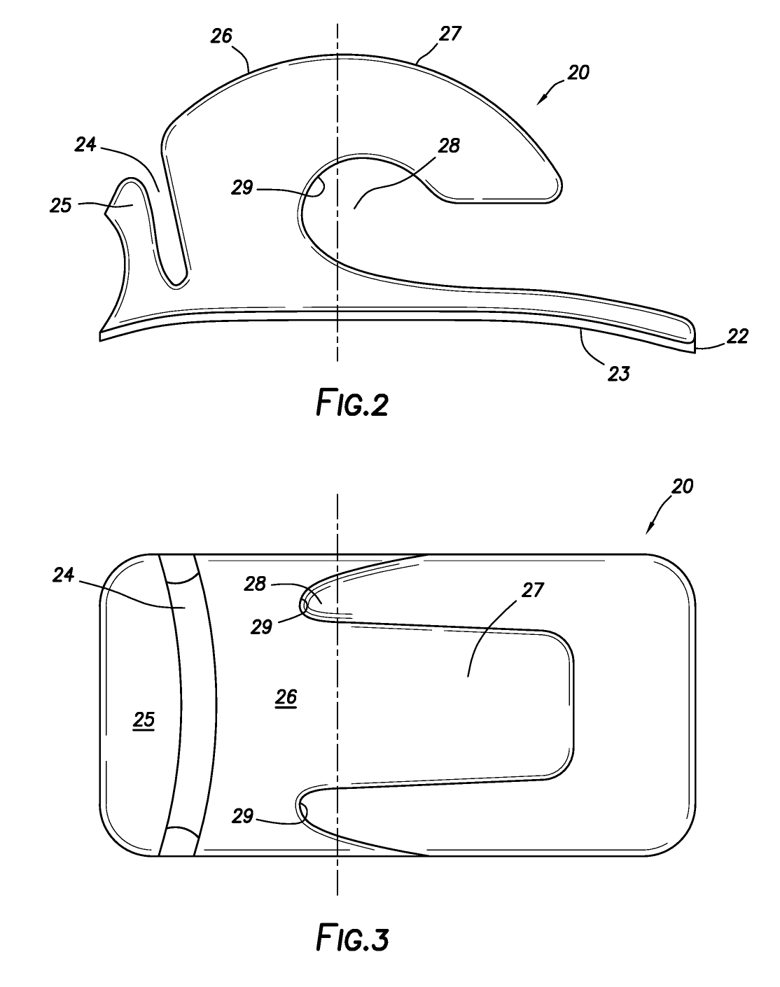

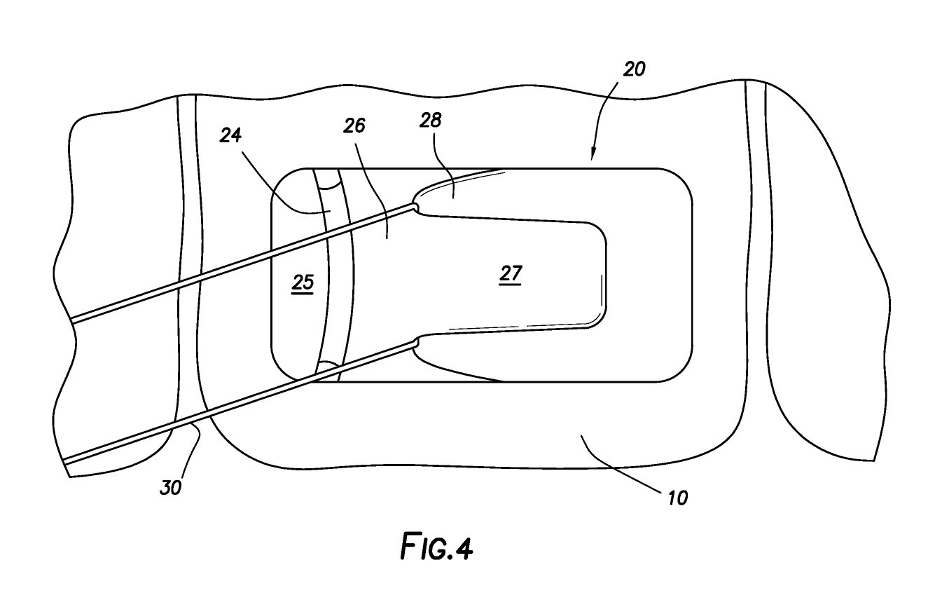

Turning to FIG. 1, an axonometric view is shown of one embodiment of an orthodontic button 20 according to the present invention. FIG. 2 is a corresponding bottom view and FIG. 3 is a side elevational view of the orthodontic button 20. The button 20 preferably includes a bonding pad 22 with a base 23 for bonding to attachment to the surface of a tooth. Preferably, the peripheral contour of the button 20 extends to the edge of the bonding pad 22 to minimize the force needed to debond the button 20 from the tooth at the end of that phase of treatment.

A vertical slot 24 in the outer face of the button 20 divides it into a larger lateral segment 25 and a smaller lateral segment 26. It should be noted that the slot is laterally offset toward a lateral edge (e.g., toward the left in the accompanying figures) of the orthodontic button 20. The slot 24 runs in a generally vertical direction and extends into the outer face of the button toward the base 23, as shown in FIG. 2. Preferably, the vertical slot 24 cuts almost completely through the body of the button 20, leaving only a relatively thin connecting segment between the larger lateral segment 25 and a smaller lateral segment 26 that can be readily compressed or deformed during the debonding process, as will be discussed below.

The vertical orientation of the slot 24 helps to reduce the risk of accidental debonding of the button 20, because the slot 24 is perpendicular to the occlusal plane and therefore is not normally subject to any substantial aberrant force. Accidental debonding forces usually occur perpendicular to the occlusal plane during mastication and clenching. Here, these forces are parallel to the axis of the vertical slot 24, and do not cause lateral compression of the slot 24 that might otherwise lead to accidental debonding.

Returning to FIGS. 1 and 2, the smaller lateral segment 26 covers a smaller portion of the base 23 and the larger lateral segment 25 covers a larger portion of the base 23. In the embodiment shown in the figures, the smaller lateral segment 26 forms an elongated arm extending outward from the base 23 adjacent to the lateral edge of the base 23. This provides leverage to peel the underlying portion of the base 23 from the tooth 10 during the debonding process. The exposed outer lateral edge of the smaller lateral segment 26 can be indented or concave to give pliers a point of purchase to squeeze the vertical slot 24 during the debonding process.

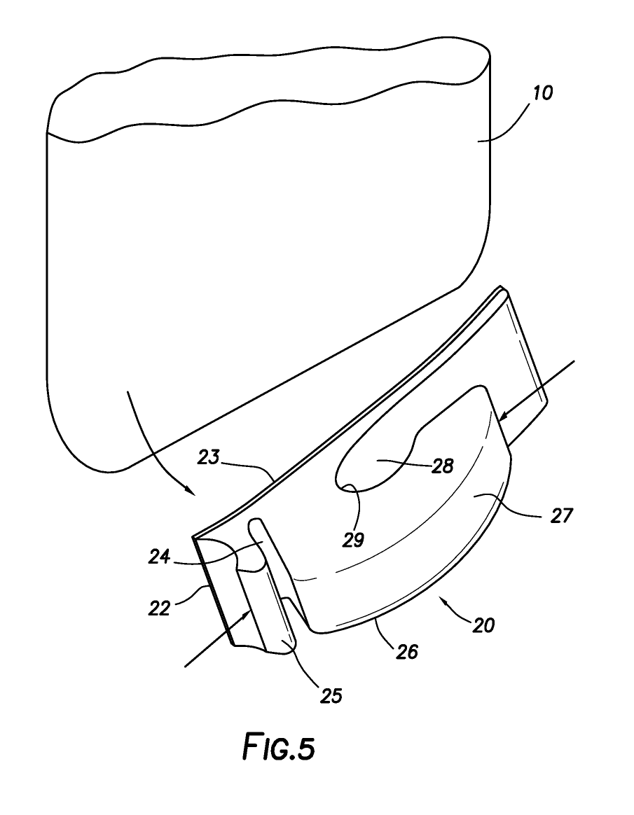

The orthodontic button 20 also includes a post 27 for removably engaging an elastic 30. The post 27 can have any of number of possible shapes and configurations. In the embodiment shown in the accompanying figures, the post 27 forms a hook that extends outward from the larger lateral segment 25 adjacent to the vertical slot 24. This post 27 curves away from the smaller lateral segment 26 to define a recess 28 between the post 27 and remaining body of the larger lateral segment 25 for removably engaging an elastic 30 as shown in FIG. 4. This recess 28 has an opening adjacent to the lateral end of the larger lateral segment 25 opposite the vertical slot 24 for receiving the elastic 30. The outer face of the post 27 (i.e., the outer surface of the post 27 opposite the base 23) can have a generally convex or rounded shape to minimize irritation to the inside of the patient's cheek. Similarly, the entire orthodontic button 20 can have a rounded or convex overall shape to minimize edges and protrusions that might cause patient discomfort.

As previously mentioned, the post 27 is preferably laterally offset toward the vertical slot 24 and the smaller lateral segment 26 (i.e., to the left of the center of the button 20 in FIGS. 2-3). As a result, the post 27 provides a point of contact 29 for the elastic 30 in the recess 28 is also laterally offset toward the smaller lateral segment 26. This configuration reduces the angle of the force vector applied by the elastic 30 to the button 20 relative to the tooth surface, which substantially increases the load-bearing capacity of the button 20. Also, the post 27 is mounted to the larger lateral segment 25 that overlays the larger portion of the bonding pad 22 and base 23, and thereby enhances the structural characteristics of this configuration.

FIG. 5 is a bottom view of the orthodontic button 20 and tooth 10 showing lateral compressive forces being exerted on the orthodontic button 20 to debond it from the tooth 10. For example, this can be done by squeezing the lateral edges of the button 20 with pliers. Exerting a lateral compressive force on the smaller lateral segment 26 and the larger lateral segment 25 compresses the vertical slot 24 and releases the base 23 from the tooth 10. In particular, the edge of the bonding pad 22 underlying the smaller lateral segment 26 initially peels off the tooth 10 as the arm of the smaller lateral segment 26 pivots about the base 23 during this process. The remainder of the base 23 can then be readily removed from the tooth 10 in one piece by continuing to peel the bonding pad 22 from the tooth 10.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

1. An orthodontic button comprising:
a base for bonding attachment to a tooth;
an outer face opposing the base;
a substantially vertical slot extending into the outer face of the button toward the base; said slot dividing the button into a smaller lateral segment covering a smaller portion of the base and a larger lateral segment covering a larger portion of the base separated by a thin connecting segment; and
a post on the larger lateral segment for removably engaging an elastic to the button;
wherein exerting a lateral compressive force on the smaller lateral segment and the larger lateral segment compresses the slot and peels the base underlying the smaller lateral segment off the tooth to release the base from the tooth.

2. The orthodontic button of claim 1 wherein the post extends outward from the larger lateral segment and curves away from the smaller lateral segment to define a recess for removably engaging an elastic.

3. The orthodontic button of claim 2 wherein the post further comprises an outer surface having a generally convex shape.

4. The orthodontic button of claim 2 wherein the recess further comprises an opening at the lateral end of the larger lateral segment opposite the vertical slot for receiving an elastic.

5. The orthodontic button of claim 1 wherein the post extends from the larger lateral segment adjacent to the vertical slot.

6. The orthodontic button of claim 1 wherein the post provides a point of contact for removably engaging an elastic that is laterally offset toward the smaller lateral segment.

7. The orthodontic button of claim 1 wherein the smaller lateral segment forms an elongated arm extending outward from the base adjacent to the lateral edge of the base.

8. An orthodontic button comprising:
a base for bonding attachment to a tooth;
an outer face opposing the base;
a substantially vertical slot extending into the outer face of the button toward the base; said slot dividing the button into a smaller lateral segment covering a smaller portion of the base and a larger lateral segment covering a larger portion of the base; and
a post extending outward from the larger lateral segment adjacent to the vertical slot and curving away from the smaller lateral segment to define a recess for removably engaging an elastic;
wherein exerting a lateral compressive force on the smaller lateral segment and the larger lateral segment compresses the slot and peels the base underlying the smaller lateral segment off the tooth to release the base from the tooth.

9. The orthodontic button of claim 8 wherein the post further comprises an outer surface having a generally convex shape.

10. The orthodontic button of claim 8 wherein the recess further comprises an opening at the lateral end of the larger lateral segment opposite the vertical slot for receiving an elastic.

11. The orthodontic button of claim 8 wherein the post provides a point of contact for removably engaging an elastic in the recess that is laterally offset toward the smaller lateral segment.

12. The orthodontic button of claim 8 wherein the smaller lateral segment forms an elongated arm extending outward from the base adjacent to the lateral edge of the base.

13. An orthodontic button comprising:
a base for bonding attachment to a tooth;
an outer face opposing the base;
a substantially vertical slot extending into the outer face of the button toward the base; said slot dividing the button into a smaller lateral segment covering a smaller portion of the base and a larger lateral segment covering a larger portion of the base;
an elongated arm extending outward from the smaller lateral segment adjacent to the lateral edge of the base; and
a post extending outward from the larger lateral segment adjacent to the vertical slot and curving away from the smaller lateral segment to define a recess providing a point of contact for removably engaging an elastic that is laterally offset toward the smaller lateral segment;
wherein exerting a lateral compressive force on the smaller lateral segment and the larger lateral segment pivots the elongated arm into the vertical slot to peel the base underlying the smaller lateral segment off the tooth.

14. The orthodontic button of claim 13 wherein the recess further comprises an opening at the lateral end of the larger lateral segment opposite the vertical slot for receiving an elastic.

15. (canceled)
